(19) United States
(12) Patent Application Publication
(10) Pub. No.: US 2007/0023141 A1
(43) Pub. Date: Feb. 1, 2007

(54) Hot melt adhesive for PTFE

(75) Inventors: Ashok K. Mehan, Union City, CA (US); Rene Jairo Revueltas, Menlo Park, CA (US); Bryan P. Williams, San Jose, CA (US)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Corporation, Middletown, PA (US)

(21) Appl. No.: 11/192,812

(22) Filed: Jul. 29, 2005

(51) Int. Cl. C08L 27/12

(52) U.S. Cl. 156/327; 525/199

(57) ABSTRACT

Hot melt adhesives include a thermoplastic terpolymer of vinylidene fluoride, tetrafluoroethylene and hexafluoropropylene and a terpolymer of glycidyl methacrylate. The adhesives will bond well to a variety of substrates, in particular substrates of very low surface energy such as polytetrafluoroethylene (PTFE).

### BACKGROUND OF THE INVENTION

1. Field of the Invention

This invention relates to hot melt adhesives, a heat recoverable article coated on at least a portion of a surface thereof with said adhesive, and to a method of bonding to a substrate using said adhesive.

2. Introduction to the Invention

It is well known that it is extremely difficult to bond to surfaces, including polymeric surfaces, having an extremely low surface energy, e.g. a surface energy of less than about 25 dynes/cm, as determined by a measurement of critical surface tension. Such surfaces include, for example, all perfluorinated polymers wherein tetrafluoroethylene is the main building block of the polymer such as polytetrafluoroethylene (PTFE) or perfluorinated ethylene-propylene copolymer (FEP) or tetrafluoroethylene perfluoroalkylvinylether copolymer (PFA).

In U.S. Pat. No. 4,197,380 to Chao et al. a hot melt adhesive capable of bonding to such surfaces is disclosed. The adhesive comprises an ethylene copolymer, a fluoroelastomer and a tackifier in specified proportions. Chao et al. disclose that the fluoropolymer content is no more than 60%, preferably less than 50%, by weight, based on the weight of the three components.

In U.S. Pat. Nos. 5,008,340 and 5,059,480 to Guerra, et al. and U.S. Pat. No. 5,143,761 to Chiotis et al. an adhesive capable of bonding such surfaces is disclosed. The adhesive comprises a thermoplastic fluoropolymer, an elastomeric fluoropolymer, a thermoplastic ethylene copolymer, a crosslinking agent, and a tackifier in specified portions. These patents disclose that the thermoplastic fluoropolymer content is not more than 80%, preferably less than 70% based on the weight of the three polymeric components.

While these adhesives perform satisfactorily in many applications, especially when used for bonding to partially fluorinated fluoropolymers like ethylene-tetrafluoroethylene copolymer (ETFE), it has been found that under certain demanding conditions where greater bond strength and/or sealing performance is desired, these adhesive are not quite good enough.

### BRIEF SUMMARY OF THE INVENTION

One aspect of this invention provides an adhesive composition comprising about 25 to about 95% by weight of the composition of a thermoplastic terpolymer of vinylidene fluoride, tetrafluoroethylene and hexafluoropropylene, the terpolymer comprising at least 35 mole % of units derived from tetrafluoroethylene, and about 5 to about 75% by weight of a terpolymer of glycidyl methacrylate, ethylene and an acrylic ester.

The adhesive composition is particularly useful for bonding to a variety of surfaces, including fluoropolymer surfaces such as polytetrafluoroethylene.

Another aspect of this invention comprises a heat-recoverable article having a coating on at least a portion of a surface thereof of an adhesive composition comprising about 25 to about 95% by weight of the composition of a thermoplastic terpolymer of vinylidene fluoride, tetrafluoroethylene and hexafluoropropylene, the terpolymer comprising at least 35 mole % of units derived from tetrafluoroethylene, and about 5 to about 75% by weight of a terpolymer of glycidyl methacrylate, ethylene and an acrylic ester.

A further aspect of this invention comprises a method of bonding one surface to another surface, which method comprises applying to one of the surfaces to be bonded an adhesive composition comprising about 25 to about 95% by weight of the composition of a thermoplastic terpolymer of vinylidene fluoride, tetrafluoroethylene and hexafluoropropylene, the terpolymer comprising at least 35 mole % of units derived from tetrafluoroethylene, and about 5 to about 75% by weight of a terpolymer of glycidyl methacrylate, ethylene and an acrylic ester; bringing the surfaces to be bonded together with said adhesive composition positioned between them; applying sufficient heat to cause the adhesive composition to melt and flow; and cooling the surfaces.

### DETAILED DESCRIPTION OF THE INVENTION

One embodiment of the present invention is an adhesive composition that includes a thermoplastic vinylidene fluoride terpolymer, and a glycidyl methacrylate terpolymer.

As used herein a copolymer is defined as a polymer derived from two or more different monomer species.

As used herein a terpolymer is defined as a polymer derived from three or more different monomer species.

A fluoropolymer is thermoplastic or elastomeric depending on the mole ratio of the monomer(s) used and the process used in its manufacture. Thermoplastic polymers melt or flow when heated, and harden when cooled. Thermoplastic polymers can usually withstand several heating and cooling cycles without affecting the properties of the polymer.

The thermoplastic vinylidene fluoride terpolymer is a polymer derived from vinylidene fluoride monomer and two or more fluorinated monomers containing ethylenic unsaturation. The fluorinated monomer can be a perfluorinated monoolefin, for example hexafluoropropylene or tetrafluoroethylene, or a partially fluorinated monoolefin which may contain other substituents, e.g. chlorine or perfluoroalkoxy, for example chlorotrifluoroethylene and perfluoroalkyl vinyl ethers, e.g. perfluoro(methyl vinyl ether); the monoolefin is preferably a straight or branched chain compound having a terminal ethylenic double bond and containing less than six carbon atoms, especially two or three carbon atoms. The polymer preferably consists of units derived from fluorine-containing monomers. When units derived from other monomers are present, the amount thereof is preferably less than 30 mole %, generally less than 15 mole %. Such other monomers include, for example, olefins containing less than six carbon atoms and having a terminal ethylenic double bond, especially ethylene and propylene.

Preferred thermoplastic terpolymers of vinylidene fluoride are derived from monomer units of vinylidene fluoride, hexafluoropropylene, and tetrafluoroethylene. More preferred terpolymers of vinylidene fluoride are commercially available from Dyneon under the trade name Dyneon™ THV, for example THV 500, THV 2030, THV 220.

Preferred thermoplastic terpolymers of vinylidene fluoride, hexafluoropropylene, and tetrafluoroethylene are derived from at least 35 mole % units of tetrafluoroethylene. More preferably the thermoplastic terpolymers are derived from at least 15 mole % units, even more preferably about 15 to about 45 mole % units of vinylidene fluoride; at least 35 mole % units, even more preferably about 35 to about 65 mole % units of tetrafluoroethylene; and at least 5 mole % units, even more preferably about 5 to about 40 mole % units of hexafluoropropylene.

The terpolymer may contain units in addition to those derived from vinylidene fluoride, hexafluoropropylene, and tetrafluoroethylene, but the amount of such additional units is less than 30 mole %, preferably less than 15 mole %.

The thermoplastic terpolymer of vinylidene fluoride is present in the adhesive composition in an amount of about 25 to about 95% by weight of the composition. Preferably the thermoplastic terpolymer of vinylidene fluoride is present in an amount of about 55 to about 90% by weight and most preferably of about 65 to about 80% by weight, all percentages being by weight based on the total weight of the components of the adhesive composition.

The terpolymer of glycidyl methacrylate is a polymer of glycidyl methacrylate and at least two other monomers. One of the at least two other monomers is an ethylenic comonomer, preferably containing a terminal ethylenic double bond. Such ethylenic comonomers are, for example, ethylene, propylene and the like. The other of the at least two other monomer units is a polar ethylenic comonomer containing at least one polar group, such as an unsaturated carboxylic acid or an alkyl ester thereof. Such polar ethylenic comonomers containing at least one polar group are, for example, methyl acrylate, acrylic acid and the like. Other ethylenic monomers containing at least one polar group may also be used.

Preferred polar groups are carboxyl groups and carboxylic ester groups, including both pendant carboxylic ester groups (derived for example from alkyl esters of unsaturated carboxylic acids) and pendant alkyl carbonyloxy groups (derived for example from vinyl esters of saturated carboxylic acids). Other polar groups include cyano groups and hydroxyl groups, which may be obtained for example by hydrolysis of copolymers containing units derived from vinyl esters. Other suitable monomers include: vinyl esters of saturated carboxylic acids containing 1 to 4 carbon atoms, especially vinyl acetate; acrylic and methacrylic acids; and alkyl (including cycloalkyl) and aryl esters, especially methyl esters, of acrylic and methacrylic acids, said esters preferably containing at most 10 carbon atoms, especially methyl methacrylate, methyl acrylate, ethyl acrylate and butyl acrylate.

The terpolymer of glycidyl methacrylate may contain units in addition to those derived from ethylene and those containing polar groups, but the amount of such additional units is preferably less than 30 mole %, particularly less than 15 mole %.

Particularly preferred as the terpolymer of glycidyl methacrylate is a terpolymer of glycidyl methacrylate, ethylene and another comonomer, preferably a polar comonomer. More preferred as the terpolymer of glycidyl methacrylate is a terpolymer of ethylene, glycidyl methacrylate, and an acrylic ester, in particular where the acrylic ester is methyl-, ethyl- or butyl-acrylate.

Suitable commercially available glycidyl methacrylate terpolymers containing glycidyl methacrylate, ethylene and methyl acrylate are sold by Arkema as Lotader® AX8900, AX8920, and especially AX8950 because of its very low viscosity.

Preferred terpolymers of glycidyl methacrylate, ethylene and an acrylic ester are derived from at least 1 mole % units, even more preferably about 5 to 15 mole % units of glycidyl methacrylate; at least 55 mole % units, even more preferably 60 to 90 mole % units ethylene; at least 5 mole % units, even more preferably 5 to 30 mole % units of an acrylic ester.

The glycidyl methacrylate terpolymer is present in the adhesive composition in an amount of about 5 to about 75% by weight. Preferably the glycidyl methacrylate terpolymer is present in an amount of about 10 to about 45% by weight, also preferably in an amount of about 20 to about 35% by weight, more preferably about 25 to about 35% by weight, all percentages being by weight based on the total weight of the components of the adhesive composition.

The term “tackifier” is used in adhesive art to denote a material which when added to an adhesive composition promotes its adhesion to a substrate, by increasing its ability to wet the substrate. Many tackifiers are known. Preferred tackifiers are low molecular weight polymers of monomers which contain ethylenic unsaturation and are free of polar groups, for example polymers of one or more compounds of the formula
R₁CH═CR₂R₃

wherein each of R₁, R₂ and R₃, which may be the same or different, is a substituted or unsubstituted alkyl (including cycloalkyl), alkenyl (including cycloalkenyl), aryl, aralkyl or alkaryl radical containing less than ten carbon atoms. Suitable such tackifiers include Piccotex 100, which is believed to be poly alphamethylstyrene/vinyltoluene copolymer hydrocarbon resin from Eastman Chemicals, Nevpene™ 9500, which is believed to be a copolymer of a mixture of aromatically and alphatically substituted ethylenes, and Piccotex™ 75, which is believed to be a copolymer of vinyl toluene and α-methylstyrene. Other tackifiers which can be used include terpene-phenolic resins (e.g. Nevillac Hard). The tackifiers used preferably have at least one of the following properties

| Brookfield Viscosity at 160° C. | 80-1500 centipoises |
|---|---|
| Ball-and-Ring Softening point | 50-136° C. |
| Molecular Weight | <3000 |

The tackifier is optional in the adhesive composition and if present should be in an amount of less than about 20% by weight. Preferably the composition contains less than 10% by weight of tackifier and most preferably less than 5% by weight, all percentages being by weight based on the total weight of the components of the adhesive composition.

The adhesive composition may contain a crosslinking component. If present, the crosslinking component preferably comprises a free radical generator, such as an organic peroxide crosslinking agent of which many are known and commercially available, such as dicumyl peroxide, benzoyl peroxide, and the like. In addition to the free radical generator, a co-crosslinking agent may be present, if desired. The co-crosslinking agent can be a multifunctional monomer capable of crosslinking the particular polymer when initiated by the free radical generator or irradiation. Typically, the co-crosslinking agent contains at least two ethylenic double bonds, which may be present, for example, in allyl, methallyl, propargyl or vinyl groups. Examples of co-crosslinking agents include triallyl cyanurate (TAC), triallyl isocyanurate (TAIC), triallyl trimellitate, triallyl trimesate, tetrallyl pyromellitate, the diallyl ester of 1,1,3-trimethyl-5-carboxy-3-(p-carboxypenyl) indan, or other multifunctional monomers such as N,N′-m-phenylene dimaleimide, or the like. Mixtures of co-crosslinking agents can be used.

The crosslinking component, i.e. the free radical generator and co-crosslinking agent, if present, is present in an amount of about 1 to about 10%, preferably about 1.5 to about 7% and most preferably about 2 to about 5%, all percentages being by weight based on the total weight of the components of the adhesive composition.

The adhesive composition may contain a blowing agent. The blowing agent is chosen so as to effect foaming and expansion of the adhesive composition at an elevated temperature normally present during the curing of the adhesive composition. Blowing agents may be gases or liquids at room temperature and pressure, or compounds which decomposes at temperatures above room temperature giving off gases. Examples of blowing agents which are gases or liquids at room temperature include air, CO₂, N₂, O₂, helium, butane, pentane, isopentane, cyclopentane, hexane, cyclohexane, heptane, isoheptane, toluene, diethyl ether, acetone, ethyl acetate, methylene dichloride, trichloroethylene, dichlorotetrafluoroethane, trichlorofluoroethane, other halogenated hydrocarbons, and the like. Blowing agents which decompose at temperatures above room temperature giving off gases may be inorganic or organic compounds. Examples of inorganic compounds include sodium hydrogen carbonate, ammonium carbonate, ammonium hydrogen carbonate, ammonium nitrite, azides, and sodium borohydride. Examples of organic compounds include azodicarbonamide or benzenesulfonyl hydrazide. Azodicarbonamide blowing agents include Celogen® AZ 130 or 3990; and modified azodicarbonamide agents include Celogen® 754 or 765, all from Uniroyal Chemical. Benzenesulfonyl hydrazide blowing agents include p,p′-oxybis(benzenesulfonyl hydrazide), sold as Celogen® OT, and p-toluenesulfonyl hydrazide, sold as Celogen® TSH, both also from Uniroyal.

The blowing agent may also be made up of a combination of agents depending on the degree of expansion desired for a particular application; and may also include a blowing agent activator such as diethylene glycol, urea, dinitrosopentamethylenetetramine (DNPT), and the like. Certain fillers, such as zinc oxide (e.g. Kadox™ 911, manufactured by Zinc Corporation of America), may also act as activators for the blowing agent. The amount of activator added will depend on the choice of blowing agent and the amount of expansion required.

The blowing agent may be encapsulated in a shell such as an expandable microsphere. The expandable microsphere can be made from a polymer such as a thermoplastic resin. MATSUMOTO MICROSPHERE is a commercially available product of thermo-expansive microcapsules, comprising thermoplastic resin, such as vinylidene chloride polymer, acrylonitrile copolymer and acrylic polymer, in which blowing agents, such as isobutane and isopentane, are encapsulated, produced by Matsumoto Yushi-Seiyaku Co., Ltd.

One preferred encapsulated blowing agent is Expancel® polymeric microballoons, manufactured by Akzo Nobel. In general, such microballoons have an unexpanded diameter between about 6 μm and about 40 μm, and an expanded diameter between about 20 μm and about 150 μm. More preferably, the encapsulated heat activated chemical compound is Expancel® 095-DU-120 or Expancel® 098-DU-120, both of which have polymeric shells comprising copolymers of acrylonitrile and methacrylonitrile, and both of which encapsulate isopentane or isooctane or mixtures thereof.

The blowing agent, if present, is present in an amount of about 1 to about 10%, preferably of about 1.5 to about 8% and most preferably of about 2 to about 6%, all percentages being by weight based on the total weight of the components of the adhesive composition.

The adhesive composition may contain an acid acceptor or scavenger. Examples of acid scavengers include inorganic oxides, hydroxides, carbonates, hydrogen carbonates, phosphates and/or other salts of zinc, calcium, magnesium, sodium, iron, nickel, cobalt, copper, aluminum, lead and the like.

The acid acceptor or scavenger, if present, is present in an amount of about 0.25 to about 5%, preferably of about 0.5 to about 4% and most preferably of about 1 to about 2%, all percentages being by weight based on the total weight of the components of the adhesive composition.

The adhesive composition may contain additional additives such as stabilizers or antioxidants, metal deactivators, flame retardants, pigments, fillers and the like. Generally, these additional additives are present in a total amount of less than about 20% by weight, based on the weight of the total composition.

The adhesive composition of this invention is particularly advantageous for sealing and/or bonding to a surface having a low surface energy, i.e. a surface energy of less than about 25 dynes/cm. Examples of such surfaces are polytetrafluoroethylene (PTFE), tetrafluoroethylene/hexafluoropropylene copolymers (FEP), tetrafluoroethylene/perfluorovinylether copolymers (PFA), tetrafluoroethylene/chlorotrifluoroethylene copolymers, and the like. The polymer may be crosslinked or uncrosslinked.

The adhesive composition is generally applied to at least part of one of the surfaces to be bonded together and then the surfaces to be bonded are brought together with the adhesive composition positioned between them. Sufficient heat is applied to cause the adhesive composition to melt and flow to fill any irregularities in the surface and the assembly is then cooled. Heating temperature is about 150° C. to 300° C., preferably about 200° C. to 250° C. The cooling temperature is about 40° C. to 100° C., preferably about 25° C. to 50° C. The adhesive composition exhibits excellent sealing between the surfaces and, in the case of PTFE surfaces, exhibits excellent bonding to the surface. The adhesive composition can, of course, be used with surfaces having higher surface energies that are much easier to bond to. Such other surfaces include polymeric and metallic surfaces.

In a preferred embodiment, the adhesive composition is coated on at least a portion of a surface of a heat recoverable article, such as a heat recoverable tubular article or wraparound sleeve. Typically the article is heat shrinkable and the adhesive composition is coated on at least a portion of the inner surface thereof or is provided as a preformed adhesive insert.

Heat-recoverable articles are articles the dimensional configuration of which may be made substantially to change when subjected to heat treatment.

Usually these articles recover, on heating, towards an original shape from which they have previously been deformed but the term “heat-recoverable”, as used herein, also includes an article which, on heating, adopts a new configuration, even if it has not been previously deformed.

In their most common form, such articles comprise a heat-shrinkable sleeve made from a polymeric material exhibiting the property of elastic or plastic memory as described, for example, in U.S. Pat. No. 2,027,962 (Currie); U.S. Pat. No. 3,086,242 (Cook et al.); and U.S. Pat. No. 3,597,372 (Cook), the disclosures of which are incorporated herein by reference. As is made clear in, for example, U.S. Pat. No. 2,027,962, the original dimensionally heat-stable form may be a transient form in a continuous process in which, for example, an extruded tube is expanded, while hot, to a dimensionally heat-unstable form but, in other applications, a preformed dimensionally heat-stable article is deformed to a dimensionally heat-unstable form in a separate stage.

In the production of heat-recoverable articles, the polymeric material may be cross-linked at any stage in the production of the article that will enhance the desired dimensional recoverability. One manner of producing a heat-recoverable article comprises shaping the polymeric material into the desired heat-stable form, heating the article to a temperature above the crystalline melting point or, for amorphous materials the softening point, as the case maybe, of the polymer, deforming the article and cooling the article whilst in the deformed state so that the deformed state of the article is retained. In use, since the deformed state of the article is heat-unstable, application of heat will cause the article to assume its original heat-stable shape.

The adhesive composition is particularly useful in heat recoverable articles such as harnesses, transitions, boots, sleeves for sealing wire or cable splices or the like. The heat recoverable article can be of any suitable polymeric material. Preferred articles comprise polyethylene, polyvinylidene fluoride, blends of vinylidene fluoride polymers, polyamides or polyesters or other thermoplastic polymer capable of being rendered heat recoverable. Such materials may be crosslinked.

Heat-recoverable articles with which the adhesive composition of this invention can be used are well known. Certain of said articles can be used for forming solder connections between electrical conductors in view of the ease of forming the connection and the quality of the connection so formed. For such applications the article, usually in the form of a sleeve, contains a quantity of solder for forming the electrical connection and a pair of fusible inserts for sealing the connection. These articles are described for example in U.S. Pat. No. 3,243,211 (Wetmore), U.S. Pat. No. 4,282,396 (Watine et al.), U.S. Pat. No. 4,283,596 (Vidalovits et al.) and U.S. Pat. No. 4,722,471 (Gray et al.), European Patent Publication No. 0,270,283, and British Patent No. 1,470,049 the disclosure of which are incorporated herein by reference, and are sold by the Raychem Protection Products group of Tyco Electronics Corporation, Menlo Park, Calif., under the trade mark “SOLDER SLEEVE” amongst others. Similar articles are also disclosed in U.S. Pat. Nos. 4,504,699 and 4,282,396, which disclosures are also incorporated herein by reference.

When used in a heat shrinkable tubular article, the adhesive composition is coated on the inner surface of the tube so that when it recovers, the adhesive composition comes into contact with the substrate. As the article is heated to cause it to recover, the adhesive composition melts and flows to fill any voids between the article and the substrate and cures. The cured adhesive composition seals the open end of the article and bonds to the substrate. The adhesive bond formed by the cured adhesive composition exhibits exceptional bond strength, even when bonded to a surface with low surface energy. Even with PTFE or PTFE-rich substrates the bond is sufficiently strong such that, in several T-peel testings, the PTFE coating delaminated from the test. The adhesive composition is expected to be excellent for other similar low energy surfaces like Teflon®-PFA or Teflon®-FEP.

The following examples illustrate adhesive compositions in accordance with this invention and use of an adhesive composition of this invention in a heat recoverable article.

### EXAMPLES A-I

Adhesive composition A having the ingredients specified in Table 1 was used as provided by the manufacturer. Adhesive compositions B-H having the ingredients and amounts thereof specified in Table 1 were prepared by blending the ingredients using a 40:1 L/D, 28 mm co-rotating twin screw extruder made by Leistritz Corporation. The extruder was fitted with general purpose screws designed for medium shear mixing. All ingredients were tumble blended together before feeding the entire mixture to the extruder screws employing a single gravimetric feeder.

TABLE 1

| | A | B | C |
|---|---|---|---|
| Vinylidene Fluoride Terpolymer #1^{a} | — | — | — |
| Vinylidene Fluoride Terpolymer #2^{b} | — | 96.50% | 54.00% |
| Vinylidene Fluoride Terpolymer #3^{c} | — | 3.00% | 3.00% |
| Vinylidene Fluoride Terpolymer #4^{d} | — | — | — |
| Vinylidene Fluoride Terpolymer #5^{e} | — | — | — |
| Glycidyl Methacrylate Terpolymer #1^{f} | 100% | — | 42.50% |
| Glycidyl Methacrylate Terpolymer #2^{g} | — | — | — |
| Tackifier #1^{h} | — | — | — |
| Antioxidantⁱ | — | 0.50% | 0.50% |
| | D | E | F |
| Vinylidene Fluoride Terpolymer #1^{a} | 21.00% | — | — |
| Vinylidene Fluoride Terpolymer #2^{b} | 33.00% | 67.00% | — |
| Vinylidene Fluoride Terpolymer #3^{c} | 3.00% | 3.00% | 3.00% |
| Vinylidene Fluoride Terpolymer #4^{d} | — | — | — |
| Vinylidene Fluoride Terpolymer #5^{e} | — | — | 67.0% |
| Glycidyl Methacrylate Terpolymer #1^{f} | 40.50% | 27.50% | 27.5% |
| Glycidyl Methacrylate Terpolymer #2^{g} | — | — | — |
| Tackifier #1^{h} | 2.00% | 2.00% | 2.00% |
| Antioxidantⁱ | 0.50% | 0.50% | 0.50% |
| | G | H | I |
| Vinylidene Fluoride Terpolymer #1^{a} | — | — | — |
| Vinylidene Fluoride Terpolymer #2^{b} | 67.00% | 71.00% | — |
| Vinylidene Fluoride Terpolymer #3^{c} | 3.00% | — | — |
| Vinylidene Fluoride Terpolymer #4^{d} | — | — | 71.00% |
| Vinylidene Fluoride Terpolymer #5^{e} | — | — | — |
| Glycidyl Methacrylate Terpolymer #1^{f} | — | 29.00% | 29.00% |
| Glycidyl Methacrylate Terpolymer #2^{g} | 27.50% | — | — |
| Tackifier #1^{h} | 2.00% | — | — |
| Antioxidantⁱ | 0.50% | — | — |

^{a}Vinylidene Fluoride Terpolymer #1: a thermoplastic terpolymer of vinylidene fluoride, tetrafluoroethylene, and hexafluoropropylene having a melting point of 165° C., commercially available as Dyneon ™ THV 500 from Dyneon ™.
^{b}Vinylidene Fluoride Terpolymer #2: a thermoplastic terpolymer of vinylidene fluoride, tetrafluoroethylene, hexafluoropropylene and perfluoroalkoxyvinylether, having a melting point of 130° C., commercially available as Dyneon ™ THV 2030 from Dyneon ™.
^{c}Vinylidene Fluoride Terpolymer #3: a thermoplastic terpolymer of vinylidene fluoride, tetrafluoroethylene, and hexafluoropropylene having a melting point of 120° C. and a blue pigment, commercially available as Dyneon ™ THV 220 CC Blue from Dyneon ™.
^{d}Vinylidene Fluoride Terpolymer #4: a thermoplastic terpolymer of vinylidene fluoride, tetrafluoroethylene, and hexafluoropropylene, commercially available as Kynar 9301 from Elf Atochem, Inc.
^{e}Vinylidene Fluoride Terpolymer #5: an copolymer of vinylidene fluoride and hexafluoropropylene, commercially available as Viton ® A-100 from DuPont ™.
^{f}Glycidyl Methacrylate Terpolymer #1: a terpolymer of ethylene, methyl acrylate, and glycidyl methacrylate, commercially available as Lotader ® AX 8950 from Arkema.
^{g}Glycidyl Methacrylate Terpolymer #2: a terpolymer of ethylene, n-butyl acrylate, and glycidyl methacrylate, commercially available as Elvaloy ® AS from DuPont ™.
^{h}Tackifier #1: a copolymer of vinyltoluene and a-methyl styrene having a softening point of 98° C., commercially available as Piccotex 100 from Eastman.
ⁱAntioxidant: an antioxidant, commercially available as Irganox 1010 from Ciba.

Test samples were made by laminating the experimental materials between two layers of a Teflon® PTFE coated fabric referred to as TFE-GLASS™ Fabric # 7109. This Premium Grade TFE-GLASS™ Fabric features an extra-heavy coating of PTFE and is supplied by Taconic Corporation, located at 136 Coonbrook Rd, Petersburgh, N.Y. 12138. This premium-grade TFE-GLASS™ fabric is designed to deliver a super-smooth surface for demanding, non-stick applications. A hydraulic press was used to heat, compress and cool the samples. The processing times, temperatures and loads used were identical for each sample with the exception of the load pressures used for Example B due to the inherently higher viscosity of this material as opposed to the others.

Sample Preparation

Compression mold windows were made from a 0.25 mm (0.010 in) thick Teflon® fabric. These windows were 300 mm (12 in) squares with a centered 250 mm (10 in) square window opening. The outside layers of the laminates were also cut from the Teflon® fabric to a 300×330 mm (12×13 in) rectangle.

A mold window was placed onto one of the laminate sheets and lined up flush with the sides and the back of the sheet. This left approximately 25 mm (1 in) overlap of the bottom sheet extended beyond the front of the mold window.

A fixed amount of adhesive composition (approximately 30 grams) was placed into the center of the mold window. Another Teflon® sheet was placed on top of the assembly and lined up flush with the sides and back of the bottom sheet with approximately a 25 mm (1 in) overlap of the sheet extended beyond the front of the mold assembly. This 25 mm (1 in) overlap is used during testing.

The mold assembly was then placed in between the two heated platens of the press with a preset temperature of 229° C. (445° F.). The material was then taken through the following sequence of events to bond the adhesive composition to the Teflon coated substrates:
1. One-minute warm-up period under a load of 3.45 MPa (500 psi).
2. Load was increased to 68.9 MPa (10,000 psi) and held for one minute.
3. Load was increased to 82.7 MPa (12,000 psi) and held for one minute. (Example 2 was taken to 124 MPa (18,000 psi).)
4. Load was released completely and sample was transferred to the cooling platens, cooled by circulating water at room temperature.
5. The load of the cooling plates was taken to 34.5 MPa (5000 psi) and held for one minute to cool the sample prior to removal from the press.
6. Load pressure was released and the sample was removed.

The sides and back of the sample assemblies were trimmed just inside the window edges leaving the 25 mm (1 in) overlap in place at the front of the assembly. The samples were cut into strips perpendicular to the front overlap of the assembly. The dimensions of these strips were 39.7 mm (1.5625 in) wide and approximately 300 mm (12 in) long.

Testing

Each of the eight adhesive compositions was tested for adhesive bond strength to Teflon. These adhesive compositions were tested using an Instron tensile tester to measure the force needed to separate the adhesive composition from the Teflon® coated fabric. The Instron settings for testing these materials were as follows:

| | | |
|---|---|---|
| 1. | Jaw Separation: | 25 mm |
| 2. | Crosshead Speed: | 500 mm/min |
| 3. | Chart Speed: | 100 mm/min |

Test samples were run in the following manner. The overlap ends of the test strip were folded back 90° from each other to form flaps. The adhesive composition was between the laminate strips. The flaps were secured in the jaws of the Instron and used for pulling the outside layers apart during testing.

With the sample firmly secured in the jaws, the chart recorder was activated and the jaw separation started. The sample was pulled apart and the force recorded until the outer layers of the laminated sample were completely separated from each other, at which point the chart recorder was then turned off, and the jaws returned to the original starting position. Six readings (seven readings for Example H) were taken from the curve displayed on the chart. This was done by using a ruler and making tick marks along the curve that were spaced equally apart. The load at these tick marks was then recorded and an average force was calculated for the test specimen. After all five specimens were run, the averaged results taken from each specimen were then calculated to get an overall average for each material.

The following results depict the average force needed to separate the outer layers of the Teflon® coated fabric from the adhesive composition sandwiched between them.

### T-Peel Testing Results

Jaw Gap=25 mm;

X-head speed=500 mm/min;

Chart Speed=100 mm/min.

### Example A

| | Force (lb.) at interval: | | | | | | |
|---|---|---|---|---|---|---|---|
| Sample | 1 | 2 | 3 | 4 | 5 | 6 | Ave. |
| 1 | 0.055 | 0.044 | 0.033 | 0.066 | 0.055 | 0.055 | 0.051 |
| 2 | 0.143 | 0.209 | 0.088 | 0.110 | 0.088 | 0.143 | 0.130 |
| 3 | 0.088 | 0.055 | 0.022 | 0.037 | 0.033 | 0.022 | 0.043 |
| 4 | 0.026 | 0.011 | 0.055 | 0.044 | 0.037 | 0.077 | 0.042 |
| 5 | 0.037 | 0.033 | 0.035 | 0.033 | 0.033 | 0.044 | 0.036 |
| | | | | | | Average | 0.061 |
| | | | | | | | (0.271 N) |

Failure Type: Adhesive

### Example B

| | Force (lb.) at interval: | | | | | | |
|---|---|---|---|---|---|---|---|
| Sample | 1 | 2 | 3 | 4 | 5 | 6 | Ave. |
| 1 | 0.44 | 0.44 | 0.44 | 0.46 | 0.44 | 0.40 | 0.44 |
| 2 | 0.64 | 0.66 | 0.66 | 0.66 | 0.44 | 0.37 | 0.57 |
| 3 | 0.46 | 0.35 | 0.33 | 0.29 | 0.29 | 0.35 | 0.34 |
| 4 | 0.49 | 0.40 | 0.29 | 0.24 | 0.29 | 0.37 | 0.34 |
| 5 | 0.75 | 0.66 | 0.35 | 0.51 | 0.48 | 0.42 | 0.53 |
| | | | | | | Average | 0.44 |
| | | | | | | | (1.96 N) |

Failure Type: Adhesive

### Example C

| | Force (lb.) at interval: | | | | | | |
|---|---|---|---|---|---|---|---|
| Sample | 1 | 2 | 3 | 4 | 5 | 6 | Ave. |
| 1 | 6.61 | 7.28 | 7.50 | 7.72 | 8.16 | 7.94 | 7.53 |
| 2 | 7.28 | 7.94 | 7.94 | 8.16 | 7.94 | 7.94 | 7.86 |
| 3 | 12.57 | 7.72 | 7.72 | 7.50 | 7.28 | 7.50 | 8.38 |
| 4 | 7.05 | 7.28 | 7.72 | 7.72 | 7.50 | 7.72 | 7.50 |
| 5 | 9.48 | 9.04 | 8.82 | 8.38 | 8.82 | 8.16 | 8.78 |
| | | | | | | Average | 8.01 |
| | | | | | | | (35.6 N) |

Failure Type: Cohesive

### Example D

| | Force (lb.) at interval: | | | | | | |
|---|---|---|---|---|---|---|---|
| Sample | 1 | 2 | 3 | 4 | 5 | 6 | Ave. |
| 1 | 3.97 | 7.50 | 5.29 | 6.17 | 4.19 | 4.19 | 5.22 |
| 2 | 14.99 | 7.94 | 5.95 | 7.50 | 4.41 | 7.72 | 8.08 |
| 3 | 22.05 | 10.58 | 9.26 | 7.94 | 4.63 | 7.72 | 10.36 |
| 4 | 14.11 | 9.04 | 9.70 | 9.04 | 8.60 | 21.38 | 11.98 |
| 5 | 9.04 | 8.60 | 8.60 | 8.16 | 8.38 | 8.38 | 8.52 |
| | | | | | | Average | 8.83 |
| | | | | | | | (39.3 N) |

Failure Type: Cohesive

### Example E

| | Force (lb.) at interval: | | | | | | |
|---|---|---|---|---|---|---|---|
| Sample | 1 | 2 | 3 | 4 | 5 | 6 | Ave. |
| 1 | 9.48 | 6.17 | 7.28 | 6.61 | 7.50 | 7.94 | 7.50 |
| 2 | 6.94 | 9.04 | 7.28 | 5.29 | 9.26 | 14.33 | 8.69 |
| 3 | 5.73 | 5.51 | 5.95 | 5.51 | 11.46 | 8.16 | 7.05 |
| 4 | 9.26 | 7.72 | 5.95 | 7.50 | 7.72 | 7.94 | 7.68 |
| 5 | 7.05 | 9.92 | 9.48 | 10.58 | 11.68 | 7.28 | 9.33 |
| | | | | | | Average | 8.05 |
| | | | | | | | (35.8 N) |

Failure Type: Cohesive

### Example F

| | Force (lb.) at interval: | | | | | | |
|---|---|---|---|---|---|---|---|
| Sample | 1 | 2 | 3 | 4 | 5 | 6 | Ave. |
| 1 | 0.53 | 0.35 | 0.35 | 0.31 | 0.18 | 0.22 | 0.32 |
| 2 | 0.35 | 0.29 | 0.22 | 0.24 | 0.35 | 0.71 | 0.36 |
| 3 | 0.22 | 0.22 | 0.24 | 0.33 | 1.54 | 0.24 | 0.47 |
| | | | | | | Average | 0.38 |
| | | | | | | | (1.69 N) |

Failure Type: Adhesive

### Example G

| | Force (lb.) at interval: | | | | | | | |
|---|---|---|---|---|---|---|---|---|
| Sample | 1 | 2 | 3 | 4 | 5 | 6 | 7 | Ave. |
| 1 | 5.07 | 2.86 | 2.43 | 5.29 | 5.95 | 2.76 | 3.30 | 3.95 |
| 2 | 4.74 | 3.42 | 1.33 | 3.57 | 3.30 | 1.43 | 3.42 | 3.03 |
| 3 | 3.57 | 3.97 | 2.98 | 4.74 | 5.07 | 3.30 | 1.98 | 3.66 |
| 4 | 3.09 | 3.09 | 0.33 | 2.20 | 3.86 | 2.43 | 2.78 | 2.54 |
| 5 | 4.96 | 5.18 | 4.30 | 3.97 | 3.31 | 2.43 | 3.09 | 3.89 |
| | | | | | | Average | | 3.41 |
| | | | | | | | | (15.1 N) |

Failure Type: Adhesive

### Example H

| | Force (lb.) at interval: | | | | | | |
|---|---|---|---|---|---|---|---|
| Sample | 1 | 2 | 3 | 4 | 5 | 6 | Ave. |
| 1 | 6.83 | 4.63 | 5.73 | 5.73 | 5.07 | 3.53 | 5.25 |
| 2 | 5.73 | 4.63 | 5.73 | 4.74 | 3.53 | 1.43 | 4.30 |
| 3 | 3.75 | 5.73 | 3.09 | 3.31 | 6.17 | 3.09 | 4.19 |
| 4 | 7.72 | 7.05 | 8.60 | 5.73 | 5.95 | 5.29 | 6.72 |
| 5 | 5.29 | 3.31 | 5.29 | 6.17 | 3.97 | 2.87 | 4.48 |
| 6 | 6.61 | 2.43 | 4.63 | 5.07 | 4.41 | 3.75 | 4.48 |
| | | | | | | Average | 4.91 |
| | | | | | | | (21.8 N) |

Failure Type: Cohesive:

### Example I

| | Force (lb.) at interval: | | | | | | |
|---|---|---|---|---|---|---|---|
| Sample | 1 | 2 | 3 | 5 | 6 | 7 | Ave. |
| 1 | 0.00 | 0.00 | 0.00 | 0.00 | 0.00 | 0.00 | 0.00 |
| 2 | 0.00 | 0.00 | 0.00 | 0.00 | 0.00 | 0.00 | 0.00 |
| 3 | 0.00 | 0.00 | 0.00 | 0.00 | 0.00 | 0.00 | 0.00 |
| 4 | 0.00 | 0.00 | 0.00 | 0.00 | 0.00 | 0.00 | 0.00 |
| 5 | 0.00 | 0.00 | 0.00 | 0.00 | 0.00 | 0.00 | 0.00 |
| | | | | | | Average | 0.00 |
| | | | | | | | (0 N) |

Failure Type: Adhesive

The T-peel testing data above shows that the adhesive composition using an elastomeric vinylidene fluoride copolymer in example F shows very low or virtually no adhesive properties for Teflon®-PTFE (polytetrafluoroethylene). Both the vinylidene fluoride terpolymer and glycidyl methacrylate single resin component examples A and B also have very low or virtually no adhesive properties for Teflon®-PTFE. In comparison, blends of thermoplastic vinylidene fluoride terpolymer and glycidyl methacrylate terpolymer exhibit much better adhesion properties. In fact, the bond was so good that the Teflon® coating actually delaminated from the test fabric in the failure mode for most Examples C, D and E. The actual peel values would have been yet higher if the Teflon® coating was thicker or stronger. These blends were found to be excellent adhesives for bonding to PTFE, while individually, neither resin component exhibited adhesive bonding to PTFE. These blends are expected to be excellent adhesives for other similar low energy surfaces like Teflon®-PFA or Teflon®-FEP. Example I is a blend using Kynar™ 9301 as the vinylidene fluoroide terpolymer which is believed to contain a less than optimal ratio of vinylidene fluoride, tetrafluoroethylene and hexafluoropropylene.

It is therefore intended that the foregoing detailed description be regarded as illustrative rather than limiting, and that it be understood that it is the following claims, including all equivalents, that are intended to define the spirit and scope of this invention.

What is claimed is:

1. An adhesive composition comprising:
(a) about 25 to about 95% by weight of the composition of a thermoplastic terpolymer of vinylidene fluoride, tetrafluoroethylene and hexafluoropropylene, the terpolymer comprising at least 35 mole % of units derived from tetrafluoroethylene; and
(b) about 5 to about 75% by weight of the composition of a terpolymer of glycidyl methacrylate, ethylene and an acrylic ester.

2. The adhesive composition in accordance with claim 1, wherein terpolymer (a) is present in an amount between 55 and 90 percent by weight; and terpolymer (b) is present in an amount between 10 and 45 percent by weight.

3. The adhesive composition in accordance with claim 1, wherein terpolymer (a) comprises at least 15 mole % of units derived from vinylidene fluoride, at least 35 mole % of units derived from tetrafluoroethylene, and at least 5 mole % units derived from hexafluoropropylene.

4. The adhesive composition in accordance with claim 1, wherein terpolymer (a) comprises about 15 to about 45 mole % of units derived from vinylidene fluoride, about 35 to about 65 mole % of units derived from tetrafluoroethylene, and about 5 to about 40 mole % units derived from hexafluoropropylene.

5. The adhesive composition in accordance with claim 4, wherein the acrylic ester is methyl acrylate.

6. The adhesive composition in accordance with claim 1, wherein the acrylic ester is methyl acrylate.

7. The adhesive composition in accordance with claim 1, wherein the acrylic ester is ethyl acrylate.

8. A heat-recoverable article having a coating on at least a portion of a surface thereof of an adhesive composition comprising:
(a) about 25 to about 95% by weight of the composition of a thermoplastic terpolymer of vinylidene fluoride, tetrafluoroethylene and hexafluoropropylene, the terpolymer comprising at least 35 mole % of units derived from tetrafluoroethylene; and
(b) about 5 to about 75% by weight of the composition of a terpolymer of glycidyl methacrylate, ethylene and an acrylic ester.

9. The heat-recoverable article in accordance with claim 8, wherein terpolymer (a) is present in an amount between 55 and 90 percent by weight; and terpolymer (b) is present in an amount between 10 and 45 percent by weight.

10. The heat-recoverable article in accordance with claim 8, wherein terpolymer (a) comprises at least 15 mole % of units derived from vinylidene fluoride, at least 35 mole % of units derived from tetrafluoroethylene, and at least 5 mole % units derived from hexafluoropropylene.

11. The heat-recoverable article in accordance with claim 8, wherein terpolymer (a) comprises about 15 to about 45 mole % of units derived from vinylidene fluoride, about 35 to about 65 mole % of units derived from tetrafluoroethylene, and about 5 to about 40 mole % units derived from hexafluoropropylene.

12. The heat-recoverable article in accordance with claim 11, wherein the acrylic ester is methyl acrylate.

13. The heat-recoverable article in accordance with claim 8, wherein the acrylic ester is methyl acrylate.

14. The heat-recoverable article in accordance with claim 8, wherein the acrylic ester is ethyl acrylate.

15. A method of bonding a surface to another surface comprising:
i) applying to one of the surfaces to be bonded an adhesive composition comprising:
(a) about 25 to about 95% by weight of the composition of a thermoplastic terpolymer of vinylidene fluoride, tetrafluoroethylene and hexafluoropropylene, the terpolymer comprising at least 35 mole % of units derived from tetrafluoroethylene; and
(b) about 5 to about 75% by weight of the composition of a terpolymer of glycidyl methacrylate, ethylene and an acrylic ester;
ii) bringing the surfaces to be bonded together with said adhesive composition positioned between them;
iii) applying sufficient heat to cause the adhesive composition to melt and flow; and
iv) cooling the surfaces.

16. The method of bonding a surface to another surface in accordance with claim 15, wherein terpolymer (a) is present in an amount between 55 and 90 percent by weight; and terpolymer (b) is present in an amount between 10 and 45 percent by weight.

17. The method of bonding a surface to another surface in accordance with claim 15, wherein terpolymer (a) comprises at least 15 mole % of units derived from vinylidene fluoride, at least 35 mole % of units derived from tetrafluoroethylene, and at least 5 mole % units derived from hexafluoropropylene.

18. The method of bonding a surface to another surface in accordance with claim 15, wherein terpolymer (a) comprises about 15 to about 45 mole % of units derived vinylidene fluoride, about 35 to about 65 mole % of units derived from tetrafluoroethylene, and about 5 to about 40 mole % units derived from hexafluoropropylene.

19. The method of bonding a surface to another surface in accordance with claim 15, wherein the acrylic ester is methyl acrylate.

20. The method of bonding a surface to another surface in accordance with claim 15, wherein the acrylic ester is ethyl acrylate.
